(19) United States
(12) Patent Application Publication
(10) Pub. No.: US 2015/0230680 A1
(43) Pub. Date: Aug. 20, 2015

(54) Trash Detecting Device and Automatic Vacumm cleaner Using the Same

(71) Applicant: EGENPOWER INC., Laguna Niguel, CA (US)

(72) Inventors: Gary LI, Dong Guan City (CN); Sheng-Chan CHIU, Burnaby (CA)

(21) Appl. No.: 14/626,466

(22) Filed: Feb. 19, 2015

(30) Foreign Application Priority Data
Feb. 20, 2014 (CN) 201410058422.4

(51) Int. Cl. A47L 9/28; G01N 29/04; A47L 9/00

(52) U.S. Cl. CPC A47L 9/2826; A47L 9/2852; A47L 9/009; G01N 29/04; A47L 2201/06; A47L 2201/04; G01N 2291/102; G01N 2291/044

(57) ABSTRACT

A trash detecting device used in an automatic vacuum cleaner is disclosed to include a trash box defining therein a trash chamber, and an ultrasonic detection module mounted in the trash box. The ultrasonic detection module includes a control circuit, a transmitter electrically connected to the control circuit and controllable by the control circuit to transmit an ultrasonic signal toward the trash chamber, and a receiver electrically connected to the control circuit and adapted for receiving an eco signal created by the ultrasonic signal being reflected off a trash in the trash chamber and transmitting the eco signal to the control circuit for processing and causing the control circuit to output an examination signal, and thus, the trash detecting device is able to detect whether the trash amount in the trash box has reached saturation.

### BACKGROUND OF THE INVENTION

1. Field of the Invention

The present invention relates to cleaning equipment technology and more particularly, to a trash detecting device and an automatic vacuum cleaner using the trash detecting device.

2. Description of the Related Art

Unlike conventional vacuum cleaners that need to be manually operated, an automatic vacuum cleaner will move on its own power within a fixed area and simultaneously implement a cleaning operation during its movement when it is started up by the user, increasing user convenience.

However, prior art automatic vacuum cleaners do not provide any design capable of detecting trash in the trash box. In addition, most users do not have the habit of regularly cleaning up the cleaner and will clean up the trash box only when the accumulated amount of trash has nearly reached a saturated condition. This can negatively affect the cleaning performance of the automatic vacuum cleaner because of the accumulation of an excessive amount of trash.

### SUMMARY OF THE INVENTION

The present invention has been accomplished under the circumstances in view. It is the main object of the present invention to provide a trash detecting device for automatic vacuum cleaner, which can automatically detect the amount of trash in the trash box, avoiding excessive accumulation of trash to negatively affect the cleaning performance.

To achieve this and other objects of the present invention, a trash detecting device comprises a trash box defining therein a trash chamber, and an ultrasonic detection module mounted in the trash box. The ultrasonic detection module comprises a control circuit, a transmitter, and a receiver. The transmitter is electrically connected to the control circuit and spaced above the bottom wall of the trash chamber at a predetermined elevation, and controllable by the control circuit to transmit an ultrasonic signal toward the trash chamber. The receiver is electrically connected to the control circuit and spaced above the bottom wall of the trash chamber at a predetermined elevation, and adapted for receiving an eco signal created by the ultrasonic signal being reflected off a trash in the trash chamber and transmitting the eco signal to the control circuit for processing. Thus, the control circuit will generate an examination signal according to the received eco signal, and then output the examination signal to a microprocessor of the automatic vacuum cleaner using the trash detecting device. When the amount of trash accumulated in the trash chamber reaches a predetermined level, the microprocessor will control a warning unit to output a warning signal, alerting the user to clean the automatic vacuum cleaner.

Preferably, the trash box comprises a trash inlet and two inspection holes respectively located in two adjacent walls thereof and respectively disposed in communication with the trash chamber. The two inspection holes are respectively disposed corresponding to the transmitter and said receiver. Thus, the transmitter can transmits the ultrasonic signal to the trash chamber through one inspection hole, and the receiver can receive the eco signal through the other inspection hole.

Preferably, the ultrasonic detection module further comprises two sleeves respectively sleeved onto the transmitter and the receiver to centralize signal, enhancing detection sensitivity.

Preferably, the ultrasonic detection module further comprises a holder base mounted in the trash box and adapted to hold the control circuit. The holder comprises two locating holes adapted to hold the sleeves respectively.

The invention also provides an automatic vacuum cleaner using the aforesaid trash detecting device. The automatic vacuum cleaner comprises a housing, a drive unit mounted in the housing, and a microprocessor mounted in the housing. The drive unit comprises two motors, and two steering wheels respectively coupled to the motors for moving the housing. The microprocessor is electrically coupled with the motors of the drive unit and the control circuit of the trash detecting device. The microprocessor has built therein a standard cleaning path program and a focused cleaning path program. When the microprocessor receives an examination signal from the control circuit of the ultrasonic detection module, the microprocessor will run the focused cleaning path program, driving the two motors to rotate the two steering wheels in carrying the housing along a focused cleaning path that is defined by the focused cleaning path program.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an exploded view of an automatic vacuum cleaner in accordance with the present invention.

FIG. 2 is an oblique top elevational view of the trash detecting device of the automatic vacuum cleaner in accordance with the present invention.

FIG. 3 is an exploded view of the trash detecting device of the automatic vacuum cleaner in accordance with the present invention.

FIG. 4 is a sectional view taken along line 4-4 of FIG. 2.

FIG. 5 is a system block diagram of the automatic vacuum cleaner in accordance with the present invention.

FIG. 6 is a schematic applied view illustrating an operating mode of the automatic vacuum cleaner in accordance with the present invention.

FIG. 7 is a schematic applied view illustrating another operating mode of the automatic vacuum cleaner in accordance with the present invention.

### DETAILED DESCRIPTION OF THE INVENTION

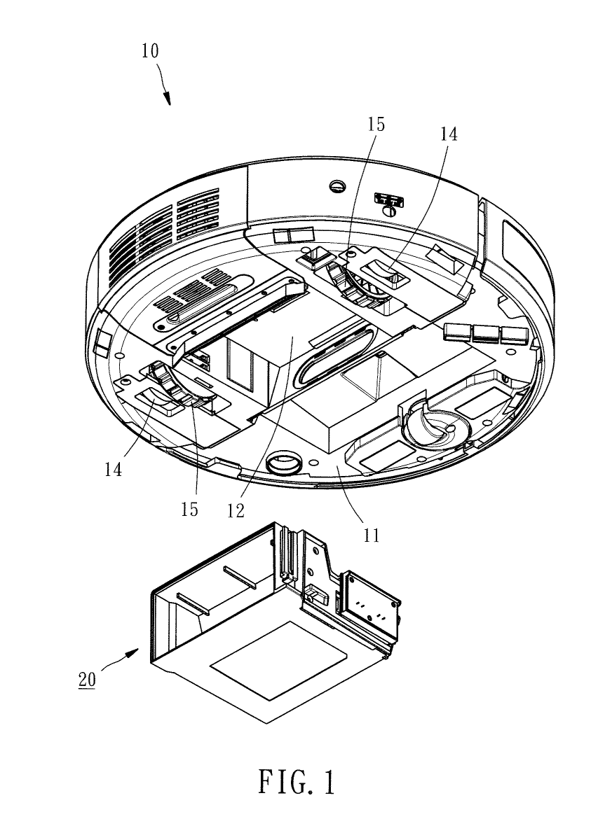

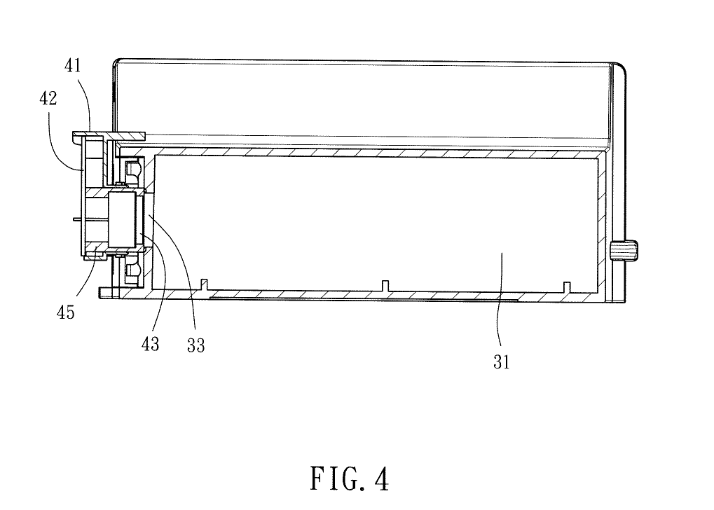

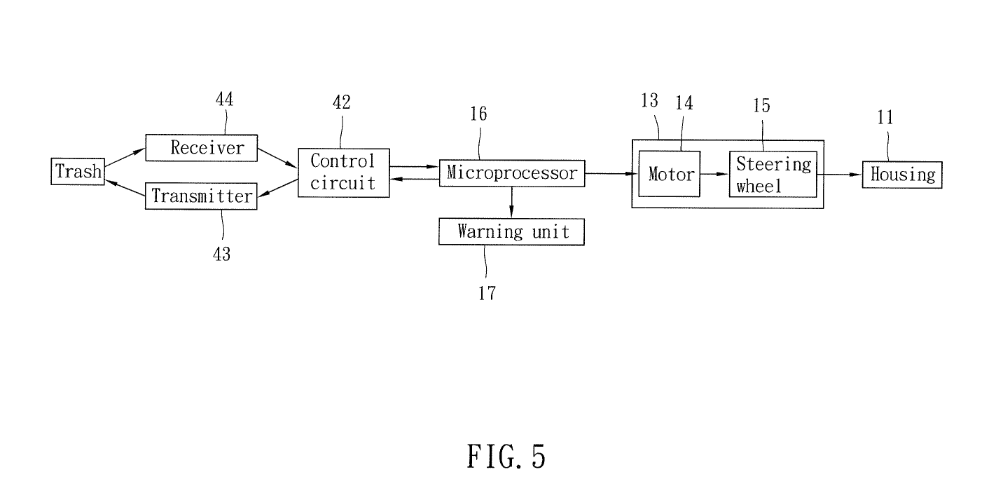

Referring to FIGS. 1 and 5, an automatic vacuum cleaner 10 in accordance with the present invention is shown. The automatic vacuum cleaner 10 comprises a housing 11 defining a mounting chamber 12 in a bottom side thereof, a drive unit 13, which comprises two motors 14 mounted in the bottom side of the housing 11 and disposed at two opposite lateral sides relative to the mounting chamber 12 and two steering wheels 15 mounted in the bottom side of the housing 11 and disposed at two opposite lateral sides relative to the mounting chamber 12 and respectively electrically connected to the motors 14, a microprocessor 16 (see FIG. 4) mounted inside the housing 11 and electrically coupled with the motors 14 and adapted for controlling the motors 14 to drive the respective steering wheels 15 in moving the housing 11, and a trash detecting device 20 mounted in the mounting chamber 12.

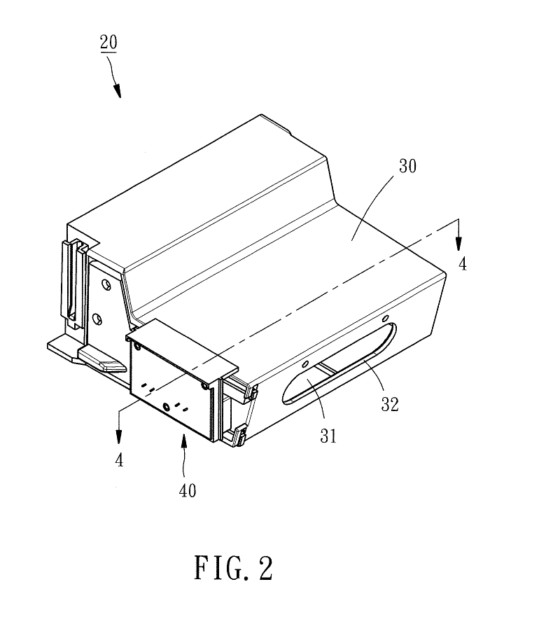

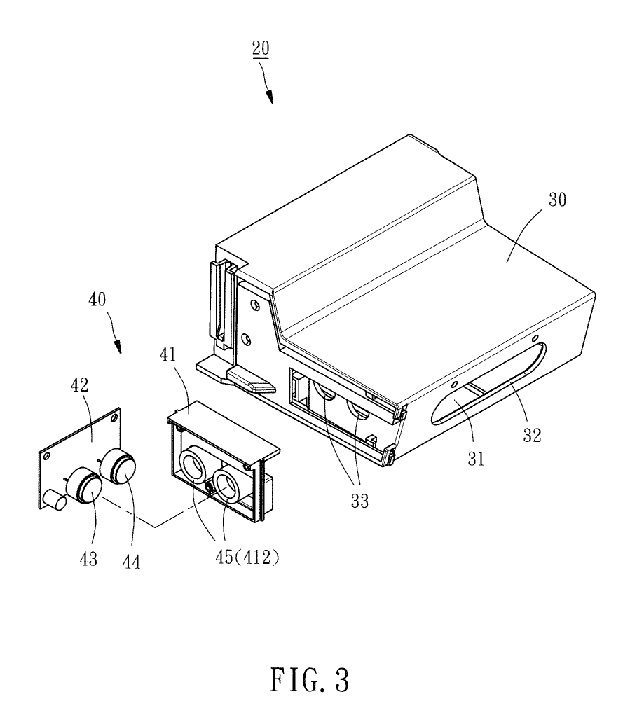

Referring to FIGS. 2 and 3, the trash detecting device 20 comprises a trash box 30 and an ultrasonic detection module 40.

The trash box 30 comprises a trash chamber 31 therein for collecting trash, a trash inlet 32 located in a front side thereof in communication with the trash chamber 31 so that trash can be moved away from the floor through the trash inlet 32 into the inside of the trash chamber 31 by a roller brush (not shown) of the housing 11, and two inspection holes 33 located in a left sidewall thereof in communication with the trash chamber 31 and at a certain elevation above a bottom wall of the trash chamber 31, as shown in FIG. 3 and FIG. 4.

As illustrated in FIGS. 3 and 4, the ultrasonic detection module 40 comprises a holder base 41, a control circuit 42, a transmitter 43, and a receiver 44. The holder base 41 is mounted at the right sidewall of the trash box 30, comprising two locating holes 412 respectively axially aimed at the inspection holes 33 of the trash box 30. The control circuit 42 is mounted at one side of the holder base 41 opposite to the trash box 30 and electrically connected to the microprocessor 16 (see FIG. 5). The transmitter 43 is electrically connected to the control circuit 42, and aimed at one inspection hole 33 of the trash box 30 through one respective locating hole 412. The receiver 44 is electrically connected to the control circuit 42, and aimed at the other inspection hole 33 of the trash box 30 through the other locating hole 412. The ultrasonic detection module 40 comprises two sleeves 45 respectively mounted in the locating holes 412 of the holder base 41 and respectively surrounding the transmitter 43 and the receiver 44 for centralized signal transmitting or receiving range to enhance detection sensitivity.

When implementing a built-in standard cleaning path program, the motors 14 are controlled by the microprocessor 16 to drive the coupled steering wheels 15 in moving the housing 11 within a work area. During movement of the housing 11 in the work area, a central vacuum unit (not shown) in the housing 11 works on the ground to perform a vacuum cleaning operation, and at the same time, the rolling brush of the housing 11 is rotated to clean the floor. On the other hand, the control circuit 42 of the ultrasonic detection module 40 is controlled by the microprocessor 16 to trigger the transmitter 43, causing the transmitter 43 to transmit a ultrasonic signal toward the inside of the trash chamber 31 for detecting the presence of trash in the trash chamber 31.

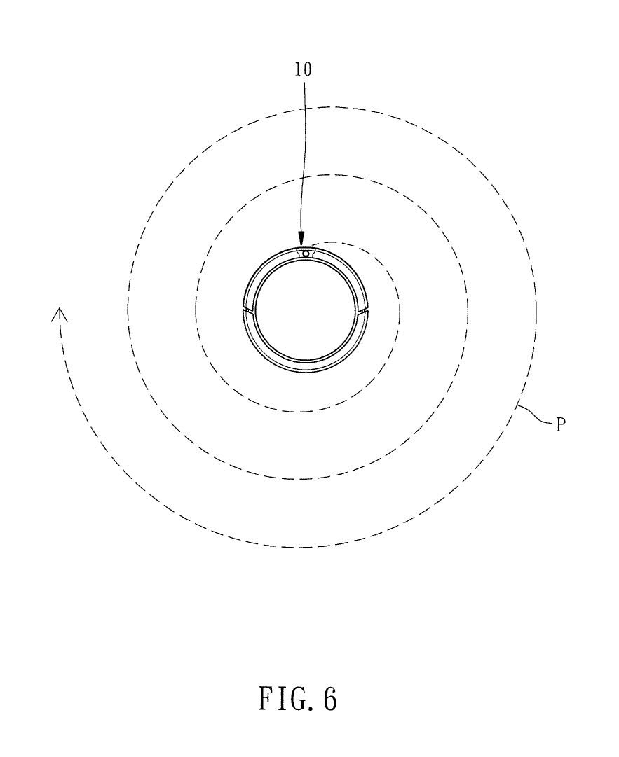

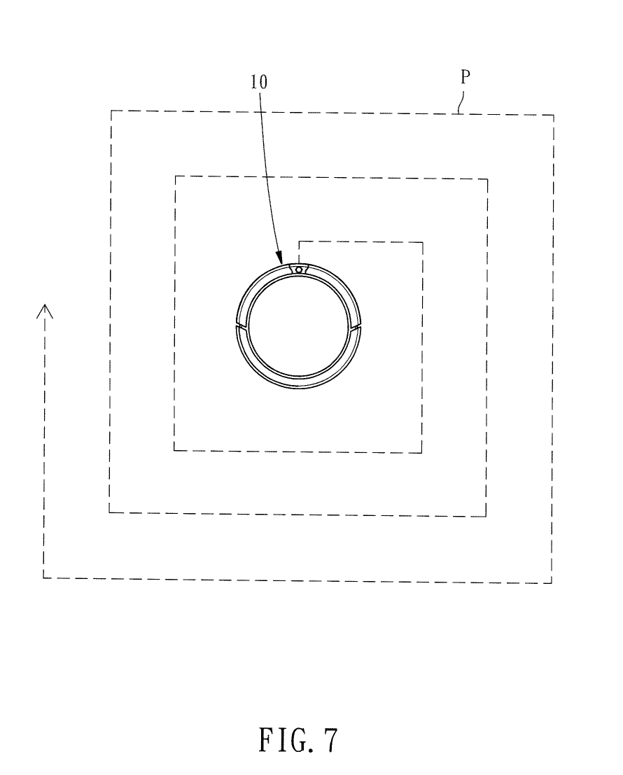

When the local trash is swept into the trash chamber 31 of the trash box 30 by the rolling brush (see FIG. 5), the ultrasonic signal transmitted by the transmitter 43 will be reflected by the trash in the trash chamber 31 to produce an eco signal. This eco signal will then be received by the receiver 44, and then transmitted by the receiver 44 to the control circuit 42. After received the eco signal from the receiver 44, the control circuit 42 will process this eco signal and then output a corresponding examination signal to the microprocessor 16. At this time, the microprocessor 16 will run a focused cleaning path program, causing the two steering wheels 15 to carry the housing 11 along a focused cleaning path P that is defined by the focused cleaning path program, strengthening the cleaning in the area around the location where trash is firstly cleaned. It is to be noted that the focused cleaning path P can be configured to exhibit an outwardly extended circular spiral pattern (see FIG. 6), or alternatively, the focused cleaning path P can also configured to exhibit an outwardly extended rectangular spiral pattern (see FIG. 7), in particular, this is not to be limited.

Further, when the amount of trash accumulated in the trash chamber 31 of the trash box 30 is increased, the distance between the accumulated trash and the ultrasonic detection module 40 will be relatively shortened, and the ultrasonic signal transmitting and receiving time length will also be relatively shorted. Thus, the microprocessor 16 can judge the amount of accumulated trash in the trash chamber 31 according to the signal receiving time length. After accumulation of a certain amount of trash in the trash chamber 31, as illustrated in FIG. 5, the microprocessor 16 will immediately control a warning unit 17 to output a warning signal (warning light or sound), alerting the user to clean the trash box 30.

In conclusion, subject to the arrangement of the ultrasonic detection module 40, the trash detecting device 20 of the present invention can rapidly and accurately detect the trash condition in the trash box 30, on the one hand allowing the automatic vacuum cleaner 10 to enhance the cleaning operation in a particular region, on the other hand allowing the automatic vacuum cleaner 10 to alert the user to clean up the cleaner, and thus, the invention achieves the objective of improving the cleaning efficiency.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A trash detection device for automatic vacuum cleaner, comprising:
a trash box defining therein a trash chamber; and
an ultrasonic detection module mounted in said trash box, said ultrasonic detection module comprising a control circuit, a transmitter and a receiver, said transmitter being electrically connected to said control circuit and spaced above a bottom wall of said trash chamber at a predetermined elevation and controllable by said control circuit to transmit an ultrasonic signal toward said trash chamber, said receiver being electrically connected to said control circuit and spaced above a bottom wall of said trash chamber at a predetermined elevation and adapted for receiving an eco signal created by said ultrasonic signal being reflected off a trash in said trash chamber and transmitting said eco signal to said control circuit for processing and output.

2. The trash detection device as claimed in claim 1, wherein said trash box comprises a trash inlet and two inspection holes respectively located in two adjacent walls thereof and respectively disposed in communication with said trash chamber, said two inspection holes being respectively disposed corresponding to said transmitter and said receiver.

3. The trash detection device as claimed in claim 2, wherein said ultrasonic detection module further comprises two sleeves respectively sleeved onto said transmitter and said receiver.

4. The trash detection device as claimed in claim 3, wherein said ultrasonic detection module further comprises a holder base mounted in said trash box and adapted to hold said control circuit, said holder comprising two locating holes, each said locating hole being adapted to hold one respective said sleeve.

5. An automatic vacuum cleaner, comprising
a housing;
a drive unit mounted in said housing, said drive unit comprising two motors and two steering wheels respectively coupled to said motors;
a trash detecting device comprising a trash box detachably mounted in said housing and an ultrasonic detection module mounted in said trash box, said trash box defining therein a trash chamber, said ultrasonic detection module comprising a control circuit, a transmitter and a receiver, said transmitter being electrically connected to said control circuit and spaced above a bottom wall of said trash chamber at a predetermined elevation and controllable by said control circuit to transmit an ultrasonic signal toward said trash chamber, said receiver being electrically connected to said control circuit and spaced above a bottom wall of said trash chamber at a predetermined elevation and adapted for receiving an eco signal created by said ultrasonic signal being reflected off a trash in said trash chamber and transmitting said eco signal to said control circuit for processing and for causing said control circuit to output an examination signal; and
a microprocessor mounted in said housing and electrically coupled with said motors of said drive unit and said control circuit of said trash detecting device and adapted for receiving said examination signal from said control circuit of said ultrasonic detection module, said microprocessor having built therein a standard cleaning path program and a focused cleaning path program, wherein when said microprocessor receives said examination signal from said control circuit of said ultrasonic detection module, said microprocessor implements said focused cleaning path program, driving said two motors to rotate said two steering wheels in carrying said housing along a focused cleaning path defined by said focused cleaning path program.

6. The automatic vacuum cleaner as claimed in claim 5, wherein said focused cleaning path exhibits an outwardly extended circular spiral pattern.

7. The automatic vacuum cleaner as claimed in claim 5, wherein said focused cleaning path exhibits an outwardly extended rectangular spiral pattern.

8. The automatic vacuum cleaner as claimed in claim 5, wherein said trash box comprises a trash inlet and two inspection holes respectively located in two adjacent walls thereof and respectively disposed in communication with said trash chamber, said two inspection holes being respectively disposed corresponding to said transmitter and said receiver.

9. The automatic vacuum cleaner as claimed in claim 8, wherein said ultrasonic detection module of said trash detecting device further comprises two sleeves respectively sleeved onto said transmitter and said receiver.

10. The automatic vacuum cleaner as claimed in claim 9, wherein said ultrasonic detection module of said trash detecting device further comprises a holder base mounted in said trash box and adapted to hold said control circuit, said holder comprising two locating holes, each said locating hole being adapted to hold one respective said sleeve.
